(19) United States
(12) Patent Application Publication
(10) Pub. No.: US 2016/0044501 A1
(43) Pub. Date: Feb. 11, 2016

(54) PROXIMITY BASED MEDIA CONTENT BLOCKER

(71) Applicant: Sinai LIBAL, Moshav Yashresh (IL)

(72) Inventor: Sinai LIBAL, Moshav Yashresh (IL)

(21) Appl. No.: 14/456,123

(22) Filed: Aug. 11, 2014

(51) Int. Cl. H04W 12/02; H04W 4/00; G06F 21/62; G06F 3/14

(52) U.S. Cl. CPC H04W 12/02; G06F 3/14; H04W 4/008; G06F 21/6245

(57) ABSTRACT

An add-on electronic control device for controlling input display screen data, comprising: a switch that is connected via an input display data connector to an image rendering source, receives a display signal from the image rendering source and conducts the display signal to a display device via an output display data connector which is adapted to be electrically and mechanically connected to a video data socket of the display device; a receiver that identifies a presence or an absence of a wireless signal originated from a target device carried by an authorized user; and a controller that controls the switch to interrupt or to maintain a conduction of the display signal to the display device according to the identified presence or the identified absence.

### FIELD AND BACKGROUND OF THE INVENTION

The present invention, in some embodiments thereof, relates to electronic display control and, more particularly, but not exclusively, to electronic display control by blocking display signal reach the display screen. Some computers and other electronic devices are used by an authorized user in a non-privet surrounding. When such display screen is left unattended, the content and information displayed on the screen connected to device may be publicly watched by others.

Some existing control solutions identify proximity of the authorized user by wireless connection. Most of these solutions include elements such as software and/or hardware incorporated in the image rendering source or the display screen.

### SUMMARY OF THE INVENTION

According to some embodiments of the present invention, there is provided an electronic control device for controlling a display screen input. The electronic control device comprises a switch comprising an input display data connector adapted to be electronically connected an image rendering source and to receives a display signal from the image rendering source, the switch further comprises an output display data connector adapted to be electrically and mechanically connected to a video data socket of a display device and adapted to conduct the display signal to the video data socket, a receiver that identifies a presence or an absence of a wireless signal originated from a target device carried by an authorized user, and a controller that controls the switch to interrupt or to maintain a conduction of the display signal to the display device according to the identified presence or the identified absence.

Optionally, at least one of the input display data connector and the output display data connector comprises a display data cable.

Optionally, the output display data connector is a video data connector configured to be electrically and mechanically connected to a video data output socket of the display device.

Optionally, the receiver is also a transmitter that transmits a signal that is returned by the target device.

Optionally, the receiver identifies strength of the wireless signal or a ping message and determines the distance of the authorized user from the receiver.

More optionally, the controller commands the switch to interrupt the display signal when the distance is larger than a predetermined distance.

Optionally, the controller commands the switch to interrupt the display signal after a predetermined time has passed from the identified absence.

Optionally, the interruption of the display signal includes elimination of the display signal.

Optionally, the interruption of the display signal includes scrambling of the display signal.

Optionally, the interruption of the display signal includes replacing the display signal by an alternative display signal.

More optionally, the controller further comprises a memory storage unit and the alternative display signal is retrieved from data stored on the memory storage unit.

Optionally, the input display data connector is a wireless communication element that receives the display signal from a broadcasting wireless communication element of the image rendering source.

Optionally, the second display data connector is a wireless communication element that broadcasts the display signal to a receiving wireless communication element of the display device.

More optionally, the electronic control device further comprises an override mechanism that forces the switch to maintain conduction of the display signal regardless of the identified presence or the identified absence.

According to some embodiments of the present invention, there is provided a method for controlling a display output. The method comprises receiving a display signal at an electronic control device electrically connected via a input display data connector to an image rendering source, operating a switch to conduct the display signal to a display device via a second display data connector, identifying a presence or an absence of a wireless signal originated from a target device carried by an authorized user, and controlling the switch to interrupt or to maintain a conduction of the display signal to the display device according to the identified presence or the identified absence.

According to some embodiments of the present invention, there is provided an electronic control device for controlling a display output. The electronic control device comprises a switch that is connected via a input display data connector to an image rendering source, receives a display signal from the image rendering source and conducts the display signal to a display device via a second display data connector, a receiver that identifies a presence or an absence of an authorized user by receiving a reading from a sensor and comparing the reading to a known pattern of the authorized user, and a controller that controls the switch to interrupt or to maintain a conduction of the display signal to the display device according to the identified presence.

According to some embodiments of the present invention, there is provided an electronic control device for controlling a display output. The electronic control device comprises a switch that is attached to a display data cable conducting a display signal from an image rendering source to a display device and interrupts or maintains the display signal by switching electromagnetic induction on or off accordingly, a receiver that identifies a presence or an absence of a wireless signal originated from a target device carried by an authorized user, and a controller that controls the switch to interrupt or to maintain a conduction of the display signal to the display device according to the identified presence or the identified absence.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an electronic control device for controlling a display output, according to some embodiments of the present invention;

FIG. 2 is a schematic illustration of an electronic control device for controlling a display output with wireless transmitter display data connector, according to some embodiments of the present invention;

FIG. 3 is a schematic illustration of an exemplary electronic control device for controlling a display output over an HDMI connector, according to some embodiments of the present invention; and

FIG. 4 is a flowchart schematically representing a method for controlling a display output, according to some embodiments of the present invention.

### DESCRIPTION OF EMBODIMENTS OF THE INVENTION

The present invention, in some embodiments thereof, relates to electronic display control and, more particularly, but not exclusively, to electronic display control by blocking display signal.

According to some embodiments of the present invention, there is provided an electronic control device for controlling a display output by preventing a transfer of display signals from an image rendering source, such as a computer and/or television, to a display device which can be separated from the image rendering source, such as a screen, based on the presence or absence of a wireless signal indicative of the presence or absence of an authorized user in a proximate area around the display screen or around a receiver of the electronic control device. The device is located along a connection between the image rendering source and the display device, for example between cables connected to them. The device includes a controller and a switch that conduct display signal or interrupt the conducting of the display signal based on instructions from the controller. The device also includes a receiver that identifies a presence or an absence of a wireless signal originated from a target device of an authorized user which is electronically connected to the controller that controls the switch according to the identified presence or absence of the wireless signal. When the authorized user which carries a target device leaves the proximate area around the device, the receiver does not intercept wireless signals from the target device, and the controller commands the switch to interrupt the display signal, for example by rerouting or blocking the signal and/or by providing another signal from an internal memory.

The device may be used for securing presented data preserving privacy, and/or for usage design. For example, the device may be used for a banker leaving a work station and needs to prevent his colleague exposure to client's detail.

Usage of the device is not dependent on the hardware of the image rendering source or on the hardware of the display screen, the type and provider of the operating system of the image rendering source, and/or an authorization required to make changes in the image rendering source. This independence is an outcome of the location of the device between the image rendering source and the display.

This device may provide a control solution that is not incorporated in the image rendering source or the display screen, and therefore may operate independently from the operation of the image rendering source or the display screen and may be easier to install as not software, firmware, and/or hardware intervention in the image rendering source is needed. This also reduces the risk of unauthorized breaches, for example due to viruses, because the device may be separate from an image rendering source connected to the internet and/or other large networks. Also, no action from the user is needed to initiate the interruption of the display signal, and it may be executed immediately without a waiting period or have a predetermined waiting period.

The device may be used in combination with existing security and privacy measures, such as password, fingerprint identification and/or facial recognition, for example in the image rendering source or in the display screen.

The device may be powered by batteries, by one of the display data connectors when it is a powered type connector, such as USB, and/or by a dedicated cable for power supply, such as AC cable.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

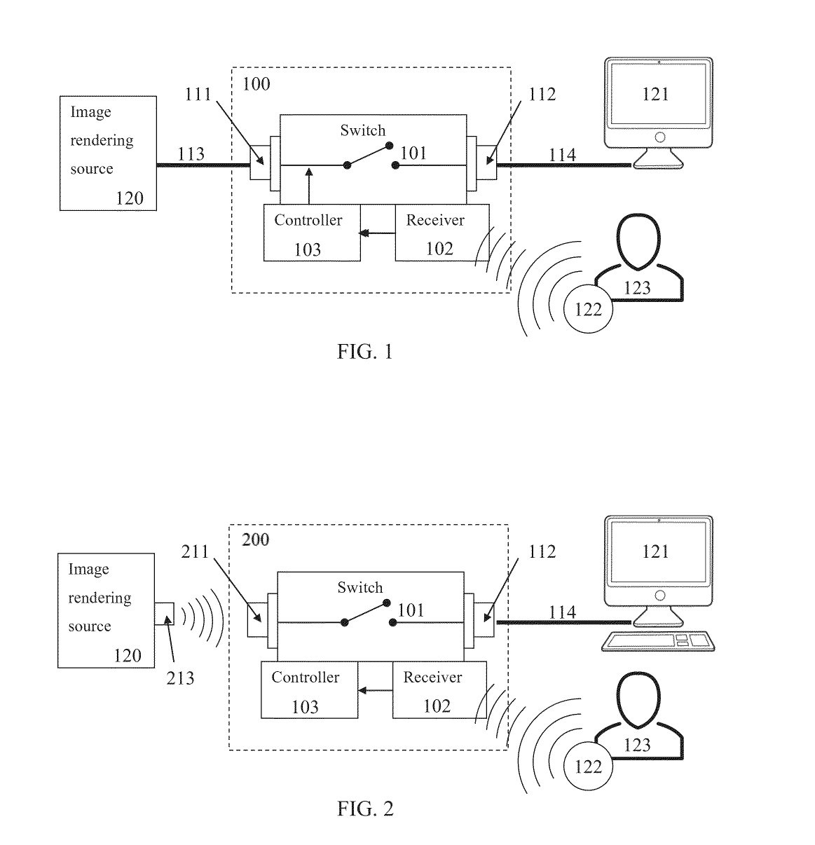

Referring now to the drawings, FIG. 1 is a schematic illustration of an electronic control device 100 for controlling a display output, according to some embodiments of the present invention. Control device 100 is a unit that is connectible between an image rendering source 120 and a display device 121, and is external to both. Reference is now also made to FIG. 2, which is a schematic illustration of an electronic control device 200 for securing a display output with wireless display data connector, according to some embodiments of the present invention.

In FIG. 1, Control device 100 includes a switch 101 electrically connected via an input display data connector 111 to image rendering source 120. Switch 101 receives a display signal from image rendering source 120. Switch 101 conducts the display signal to display device 121 via an output display data connector 112 which is adapted to be electrically and mechanically connected to a data socket of display device 121, for example a video data socket.

Switch 101 may be any kind of electrical component that can break an electrical circuit, interrupting the current or diverting it from one conductor to another. This breaking may be done by electronically or mechanically disconnecting each connection pin between input display data connector 111 and output display data connector 112. Switch 101 may be one-way, two-way, double-pole and/or any other type.

Image rendering source 120 may be any kind of hardware, for example, a personal computer, a streamer, a workstation computer, a television tuner, a video game console, a video camera, a home theater system and/or any other device electronically creating a display signal.

Input display data connector 111 may be a video data connector configured to be electrically and mechanically connected to a video data output socket of image rendering source 120. Input display data connector 111 may be any type of connector for receiving display signals, for example, TV aerial plug, Separate Video (S-Video), Radio Corporation of America (RCA) plug, Graphics Array (VGA) such as D-sub 15, mini sub D15, mini D15, DB-15, HDB-15, HD-15 or HD15, Digital Visual Interface (DVI), High-Definition Multimedia Interface (HDMI), DisplayPort, and/or any other connector according to the data socket of display device 121. Input display data connector 111 may also be other data transmission connector, such as Universal Serial Bus (USB), Ethernet, FireWire (IEEE 1394) and/or Parallel port.

Optionally, input display data connector 111 includes a display data cable 113, when a distance exists between image rendering source 120 and switch 101. Display data cable 113 is of a type compatible with input display data connector 111.

Display device 121 may be any kind of image and/or video output device, such as a computer screen, a television device, a video projector and/or any other device. Display device 121 may be of any display technology, such as cathode ray tube display (CRT), plasma display panel (PDP), liquid crystal display (LCD), light-emitting diode display (LED), organic light-emitting diode display (OLED), electronic ink and/or any other current or future technology.

Output display data connector 112 may be a video data connector configured to be electrically and mechanically connected to a video data socket of display device 121, may be any of any type and/or include a display data cable 114, as described above for input display data connector 111. Output display data connector 112 may be of the same type as input display data connector 111 or of a different type compatible with input display data connector 111. For example, input display data connector 111 is DVI-I while output display data connector 112 is VGA.

In FIG. 2, input display data connector 111 is a wireless communication element ¹211 that receives the display signal from a broadcasting wireless communication element 213 of image rendering source 120. Optionally, input display data connector 111 is a wireless communication element that broadcasts the display signal to a receiving wireless communication element of display device 121. Optionally, electronic control device 100 is incorporated in a wireless digital media player device, such as Chromecast.

In both FIG. 1 and FIG. 2, Electronic control device 100, 200 also includes a receiver 102 that identifies a presence or an absence of a wireless signal originated from a target device 122 of an authorized user 123. Optionally, receiver 102 is also a transmitter that transmits a signal that is then returned by target device 122. Optionally, receiver 102 and target device 122 are paired, for example by Bluetooth™ pairing, so they may connect to each other without requiring confirm the identity of the devices.

Optionally, receiver 102 identifies multiple authorized users having multiple target devices.

The wireless signal may be of any kind, for example, wireless local area network (WLAN) protocol such as Wireless Fidelity (WiFi™), a wireless personal area network (WPAN) such as Bluetooth™ protocol, private radio network, cellular network or any other form of wireless communication.

Target device 122 may be, for example, a radio-frequency identification (RFID) chip, an active antenna, a proximity card and/or any other device transmitting a wireless signal. Target device 122 may be incorporated in any device and/or object of authorized user 123, such as an identification (ID) card, an employee tag, a keychain, a wristwatch, a cellular phone, a Smartphone, a smart electronic glasses and/or any other object. Optionally, receiver 102 identifies a presence or an absence of a wireless signal from a device of authorized user 123 when the device connects to a home network.

Receiver 102 may be positioned near switch 101 or may be remote from switch 101. For example, receiver 102 may be located on display device 121 so as to identify when authorized user 123 is very close to display device 121, while switch 101 is located close to image rendering source 120 further from authorized user 123 and connected to display device 121 via a long cable. Receiver 102 may than communicate with switch 101 via a communication cable or via wireless communication.

Optionally, receiver 102 identifies only one of two options, presence or absence of the wireless signal of target device 122. Optionally, receiver 102 identifies the strength of the wireless signal of target device 122 or a ping message from the wireless signal of target device 122 and uses this to determine the distance of authorized user 123 from receiver 102.

Optionally, receiver 103 identifies the presence of authorized user 123 by receiving a reading from a sensor such as heat sensor, movement sensor and/or volume sensor, and comparing the reading to a known unique signature reading associated with authorized user 123.

Electronic control device 100 also includes a controller 103 that contains the logic such as code to operate switch 101 to interrupt or to maintain a conduction of the display signal to display device 121 according to the identified presence or absence. Controller 103 may be located near switch 101 or may be remote from switch 101, for example attached to target device 122 or to receiver 102. Controller 103 may communicate with switch 101 and/or with receiver 102 via a communication cable or via wireless communication.

When receiver 102 indicates that authorized user 123 is distant, controller 103 commands switch 101 to interrupt the display signal. Controller 103 may manage any logic pattern. Optionally, controller 103 manages different logic patterns for different authorized users. Optionally, the logic of controller 103 may be configurable by authorized user 123.

Optionally, controller 103 may command switch 101 to interrupt the display signal when the distance of authorized user 123 from receiver 102 is larger than a predetermined distance, for example, 1, 3, 15 meters, and/or any shorter, longer or intermediate distance.

Optionally, controller 103 may command switch 101 to interrupt the display signal only after a predetermined time has passed after receiver 102 identifies that authorized user 123 is distant, for example, 1 second, 30 seconds, 1 minute and/or any shorter, longer or intermediate time period.

Optionally, controller 103 may command switch 101 to interrupt the display signal after a predetermined time has passed that receiver 102 identifies that authorized user 123 is present, for example, for limiting the time of watching television by blocking the signal when the authorized user is near it for longer than a certain period, such as 1, 2, 3, 4 hours a day/a week.

Optionally, controller 103 may be correlated with other software and/or hardware such as apps installed in Smartphones and/or tablet computers and/or with dongles connected to other screens. For example, when controlling a signal from a television tuner to prevent children from watching the television when parents are not present, controller 103 may be correlated with parental usage monitors such as apps for usage control.

The display signal may be completely eliminated by switch 101, may be scrambled and/or may be replaced by an alternative display signal, for example, a message saying the screen is locked. Optionally, the device also includes a memory storage unit and the display signal is replaced by an alternative display signal that is based on data stored on the memory storage, such as an image and/or video.

Optionally, the device also includes an override mechanism that forces switch 101 to maintain the conduction of the display signal regardless of the presence or absence of the wireless signal. The override mechanism may include an override button for the user for manual command to maintain the conduction, for example, when the device is malfunctioned.

Optionally, switch 101 interrupts the display signal by electromagnetic induction or any other external effect which is applied on the signal. Optionally, switch 101 is attached to the jacket of a display data cable between image rendering source 120 and display device 121 and interrupts the display signal by electromagnetic induction from outside the display data cable.

Optionally, electronic control device 100 includes a battery or multiple batteries, disposable and/or rechargeable. Optionally, electronic control device 100 receives electricity power from input display data connector 111 and/or output display data connector 112. This is possible when input display data connector 111 is a powered type connector, such as USB, and/or may include the required power in the conducted display signal. Optionally, electronic control device 100 includes a cable for power supply, such as AC cable connected to an AC outlet and/or USB cable connected for example to image rendering source 120.

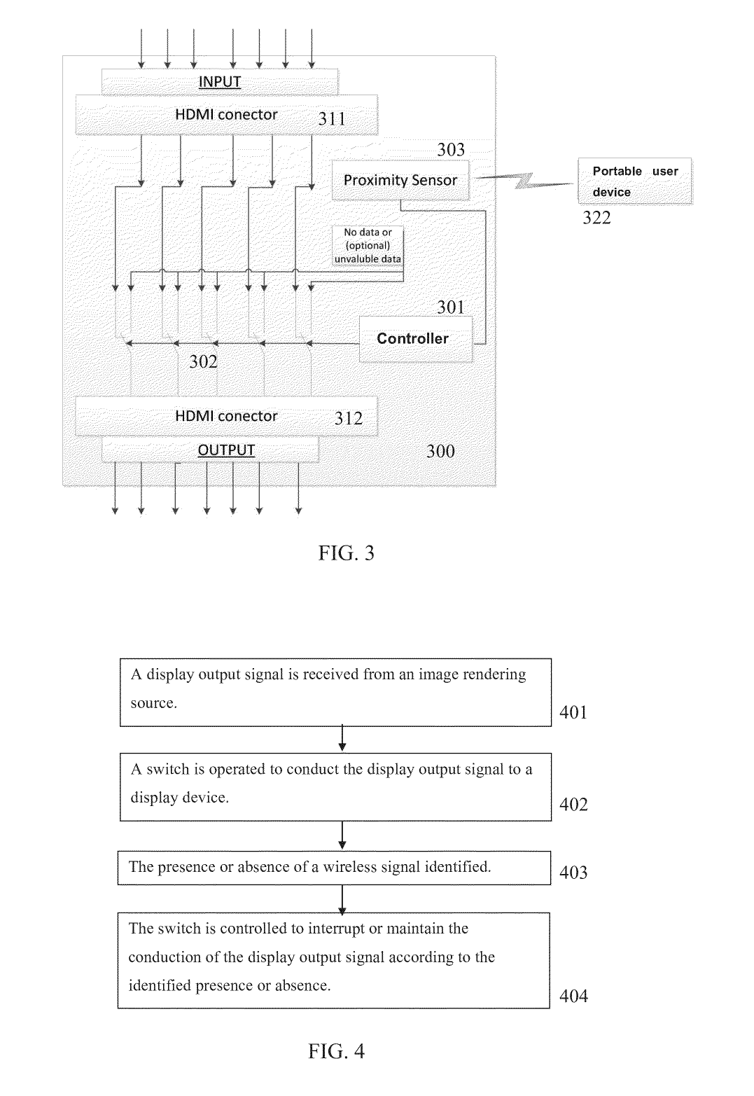

Reference is now made to FIG. 3, which is a schematic illustration of an exemplary electronic control device 300 for securing a display output over an HDMI connector, according to some embodiments of the present invention.

A display signal is received through HDMI connector 311 from an image rendering source and is conducted trough HDMI connector 312 to a display device. A proximity sensor 303 identifies that portable user device 322 of the authorized user is distant, and alerts controller 301. Controller 301 then commands switch 302 to interrupt the display signal by switching to an internal input of different data.

Reference is now also made to FIG. 4, which is a flowchart schematically representing a method for securing a display output, according to some embodiments of the present invention.

First, as shown at 401, a display signal is received at electronic control device electrically 100 connected via input display data connector 111 to image rendering source 120.

Then, as shown at 402, switch 101 is operated to conduct the display signal to display device 121 via output display data connector 112. In this state, the display signal to display is conducted from image rendering source 120 to display device 121 through input display data connector 111 and output display data connector 112.

Then, as shown at 403, the presence or absence of a wireless signal originated from a target device 122 carried by authorized user 123 is identified by receiver 103. The identified presence or absence of the wireless signal is transferred by receiver 103 to controller 103.

Finally, as shown at 404, switch 101 is controlled by controller 103 to interrupt or to maintain the conduction of the display signal to display device 121 according to the identified presence or absence of the wireless signal. When absence of the wireless signal is identified, controller 103 commands switch 101 to electronically or mechanically disconnect each connection pin between input display data connector 111 and output display data connector 112, so the display signal is not conducted to display device 121.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems of electronic display control will be developed and the scope of the term electronic display is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An electronic control device for controlling a display screen input, comprising:
a switch comprising an input display data connector adapted to be electronically connected an image rendering source and to receives a display signal from said image rendering source, said switch further comprises an output display data connector adapted to be electrically and mechanically connected to a video data socket of a display device and adapted to conduct said display signal to said video data socket;
a receiver that identifies a presence or an absence of a wireless signal originated from a target device carried by an authorized user; and
a controller that controls said switch to interrupt or to maintain a conduction of said display signal to said display device according to said identified presence or said identified absence.

2. The electronic control device of claim 1, wherein at least one of said input display data connector and said output display data connector comprises a display data cable.

3. The electronic control device of claim 1, wherein said output display data connector is a video data connector configured to be electrically and mechanically connected to a video data output socket of said display device.

4. The electronic control device of claim 1, wherein said receiver is also a transmitter that transmits a signal that is returned by said target device.

5. The electronic control device of claim 1, wherein said receiver identifies strength of said wireless signal or a ping message and determines the distance of said authorized user from said receiver.

6. The electronic control device of claim 5, wherein said controller commands said switch to interrupt said display signal when said distance is larger than a predetermined distance.

7. The electronic control device of claim 1, wherein said controller commands said switch to interrupt said display signal after a predetermined time has passed from said identified absence.

8. The electronic control device of claim 1, wherein said interruption of said display signal includes elimination of said display signal.

9. The electronic control device of claim 1, wherein said interruption of said display signal includes scrambling of said display signal.

10. The electronic control device of claim 1, wherein said interruption of said display signal includes replacing said display signal by an alternative display signal.

11. The electronic control device of claim 13, further comprising a memory storage unit and said alternative display signal is retrieved from data stored on said memory storage unit.

12. The electronic control device of claim 1, wherein said input display data connector is a wireless communication element that receives said display signal from a broadcasting wireless communication element of said image rendering source.

13. The electronic control device of claim 1, wherein said second display data connector is a wireless communication element that broadcasts said display signal to a receiving wireless communication element of said display device.

14. The electronic control device of claim 1, further comprising includes an override mechanism that forces said switch to maintain conduction of said display signal regardless of said identified presence or said identified absence.

15. A method for controlling a display output, comprising:
receiving a display signal at an electronic control device electrically connected via an input display data connector to an image rendering source;
operating a switch to conduct said display signal to a display device via a second display data connector;
identifying a presence or an absence of a wireless signal originated from a target device carried by an authorized user; and
controlling said switch to interrupt or to maintain a conduction of said display signal to said display device according to said identified presence or said identified absence.

16. An electronic control device for controlling a display output, comprising:
a switch that is connected via an input display data connector to an image rendering source, receives a display signal from said image rendering source and conducts said display signal to a display device via a second display data connector;
a receiver that identifies a presence or an absence of an authorized user by receiving a reading from a sensor and comparing said reading to a known pattern of said authorized user; and
a controller that controls said switch to interrupt or to maintain a conduction of said display signal to said display device according to said identified presence.

17. An electronic control device for controlling a display output, comprising:
a switch that is attached to a display data cable conducting a display signal from an image rendering source to a display device and interrupts or maintains said display signal by switching electromagnetic induction on or off accordingly;
a receiver that identifies a presence or an absence of a wireless signal originated from a target device carried by an authorized user; and
a controller that controls said switch to interrupt or to maintain a conduction of said display signal to said display device according to said identified presence or said identified absence.
